(19) United States
(12) Patent Application Publication
(10) Pub. No.: US 2009/0177178 A1
(43) Pub. Date: Jul. 9, 2009

(54) CONNECTOR DEVICE AND METHOD FOR STERILE MIXING

(75) Inventor: Erik Carsten Pedersen, Odense (DK)

Correspondence Address: O''Shea Getz P.C., 1500 MAIN ST. SUITE 912, SPRINGFIELD, MA, 01115, US

(73) Assignee: POLIMOON MEDICAL PACKAGING A/S, LANGSKOV (DK)

(21) Appl. No.: 12/374,599

(22) PCT Filed: Jul. 5, 2007
(86) PCT No.: PCT/DK2007/000343

§ 371 Date: Feb. 10, 2009

(30) Foreign Application Priority Data
Jul. 21, 2006 (DK) PA 2006 01007

(51) Int. Cl. A61J 1/20

(52) U.S. Cl. 604/414

(57) ABSTRACT

The invention relates to a connector device for establishing fluid communication between a first and a second container. The device includes a first tube member for engaging the first container and a second tube member in fluid communication with said first tube member at a first end and having at a second end an engagement member for engagement of said second container. The second tube member includes a second piercing means. The engagement member allows, in an activated position, for piercing of the second container by the second piercing means and prevents separation of the second container and the device, so that the piercing of the second container cannot be undone, and so that the second container cannot be separated from the connector device after it has been pierced.

This application is entitled to the benefit of, and incorporates by reference essential subject matter disclosed in PCT Application No. PCT/DK2007/000343 filed on Jul. 5, 2007, which claims priority to Denmark Application No. PA 2006 01007 filed Jul. 21, 2006.

### BACKGROUND OF THE INVENTION

1. Technical Field

The present invention relates to a connector device for establishing fluid communication between a first container and a second container.

The invention also relates to a method for sterile mixing of the contents of a first container and the contents of a second container.

The invention further relates to the use of a device according to the invention.

2. Background Information

WO 95/13785 relates to a decanting device for medical or pharmaceutical practice, for instance to decant an active substance into a solution. A container for an active substance concentrate, a collecting container and a dosing pump are attached to a closed housing and connected with a multipath distributor which alternately establishes first a connection between the active substance concentrate container and the dosing pump and then a connection between the dosing pump and the collecting container. In this way, a set amount of active substance concentrate may be extracted and conveyed into the collecting container. The containers and the dosing pump are releasably attached to the closed housing by means of threads or pinch couplings.

WO 99/03528 discloses an aseptic connection device comprising a first connecting means and a second connecting means which are releasably interconnectable by means of threads. The first connecting means comprises an injection needle and a protecting sleeve having an orifice that can be punctured. The second connecting means comprises a rubber-like part that is penetrable by the needle.

The present invention is generally within the field of delivery of pharmaceutical solutions to patients. A very large number of different pharmaceutical compounds are administered to patients as solutions, typically by use of a flexible container containing the solution and being attached by tubes to an intravenous (IV) catheter. Some pharmaceutical solutions are provided as ready-for-use solutions, but very often, the pharmaceutical compound is provided in a solid form, typically as a sterile powder. Such powders have to be reconstituted in a diluent liquid before being administered to the patient. Different liquids may be used as diluents. Very common ones are saline solutions, such as an isotonic potassium chloride solution, and dextrose solutions. The diluents are typically provided in a pre-filled sterile container, such as a flexible polymer container of the bag-type, which is very common in hospitals. The sterile powder or other pharmaceutical compound is typically provided in a small bottle commonly known as a vial. Sometimes the pharmaceutical compound is provided as a concentrate, which then has to be diluted, rather than reconstituted, in the diluent.

In order to reconstitute the solid pharmaceutical compound it has to be brought into contact with the diluent. Since the final solution is typically to be administered IV to the patient, it is very important that the reconstitution is carried out without any risk of contamination of the diluent, solid or final solution. Thus, it is known and practiced in the art to provide a sterile fluid connection between the diluent container and the vial. Typically, the solid in the vial can be reconstituted simply by allowing diluent to enter the vial and thereby allowing the diluent and solid to mix. Sometimes the mixing can be facilitated by either shaking the connected vial and diluent container or alternatively by pressing and releasing the diluent container to push diluent into the vial and create a current in the liquid.

After proper reconstitution of the solid in the diluent, the final solution is typically administered to a patient by mounting one end of a tube with a drip-chamber to the diluent container and attaching the other end to an IV catheter. The flow can optionally be controlled and monitored by an infusion pump. Often, however, the diluent container is simply placed above the patient, so that gravity will cause the solution to flow from the container to the patient. In such cases the flow can be controlled by use of a mechanical adjustable clamp attached to the tube.

As mentioned previously, it is of the utmost importance that the final solution, which is to be administered to a patient, remains sterile. Thus, it is very important that the equipment used to reconstitute the solid pharmaceutical compound minimizes any risk of contamination by either being easy to sterilise after use, or by being designed as disposable single-use items.

Furthermore, a large number of the pharmaceutical solids and resulting solutions used for IV therapy, such as chemotherapeutic agents, are toxic and potentially harmful to hospital personnel. Other substances for IV administration, such as antibiotics, may not be directly toxic, but may still be potentially harmful to the environment. It is therefore a requirement of hospital staff as well as authorities, that all possible measures should be taken to avoid spillage or leaks of the pharmaceutical solids and solutions. This obviously includes constructing the equipment used for reconstitution in a way that minimizes the risk of spillage and leaks.

A further requirement of hospital personnel, which is linked to reducing the above risks, is that the equipment should be easy to use. Ease of use also implies that it should be made as hard as possible to misuse or damage the equipment in any way. One way to achieve ease of use is to design the equipment as disposable single-use items as this eliminates the task of sterilising equipment after use.

An additional requirement is that it should be clear from the equipment used for reconstitution that it has been used. This would reduce the risk of re-use of contaminated equipment. Also, it would help minimize the risk of the potentially very harmful situation where more than one vial of pharmaceutical compound is reconstituted in the same diluent, thus doubling the concentration of the final solution. To eliminate the problem of accidentally reusing contaminated equipment, many users require that the equipment is designed so that it is only technically possible to use it once.

Moreover, equipment designed for single-use is preferable in several usage situations, as this eliminates the risk of contamination following repeated use or faulty sterilisation. A further advantage of single-use equipment is that it makes the equipment easier and faster to use since it eliminates the need for sterilisation. Nevertheless, a single-use design poses greater challenge to the supplier of the equipment, in order to make it economically sound.

As mentioned previously, it is known in the art to mix, reconstitute or dilute a pharmaceutical compound or composition in a diluent under sterile conditions. However, the prior art still fails to provide an optimal solution to the above mentioned problems and requirements. As a perfect illustration of this unmet need, hospital personnel as well as health authorities are currently demanding new and improved solutions to their problems within the area of making final solutions for IV administration. The currently available equipment fails to meet the combined requirements of e.g. ease of use, minimized risk of contamination, minimized risk of leaks, and safety for the user.

There is thus a need to provide equipment for use in reconstituting or diluting pharmaceuticals for IV administration which remedies the shortcomings of the prior art. More specifically, there is a need to provide such equipment, which minimizes the risks of contamination, leaks, and spillage while at the same time being easy and safe to use. There is also a need to provide such equipment, which allows the user to quickly and easily ascertain whether or not the equipment has been or is currently in use. Moreover, there is a need for economically sound single-use equipment to enable easy and fast use and in order to eliminate the risk of contamination following re-use. There is a further need to provide such equipment, which may safely be re-used without increased risk of contamination.

### SUMMARY OF THE INVENTION

In a device in accordance with the present invention, the device comprises a first tube member having a first end for engaging the first container and a second end for discharge of fluid from the device, said device further comprising a second tube member in fluid communication with said first tube member at a first end, and having at a second end an engagement member for engagement of said second container. The second tube member comprises a second piercing means, such as a syringe or needle. In an activated position, the engagement member allows for piercing of the second container by the second piercing means and prevents separation of the second container and the device, so that the piercing of the second container cannot be undone, and so that the second container cannot be separated from the connector device after it has been pierced.

That the second container can not separated from the connection device after it has been pierced ensures a 100% traceability of the medication given to the patient, and thus rules out the possibility of double-medication.

The device according to the invention has two means for engaging the two containers: the first end of the first tube member and the engagement member at the second end of the second tube member. Once the two containers have been engaged, fluid communication between them can be achieved and thus their respective contents can be mixed. The piercing means is suitable for penetrating into the second container, e.g. through a seal or cap. Specifically, a hollow piercing means may also act as a conduit of fluid between the second container and the second tube member.

The engagement member can be moved at least between an activated and a non-activated position. In the activated position, a second container engaged by the engagement member will be pierced by the second piercing means, which are comprised in the second tube member.

In an embodiment, said engagement member has a sliding connection to said second tube member.

In an embodiment, said engagement member is adapted to be gradually “clicked” on to the second tube member. Preferably, said engagement member has a threaded connection to said second tube member. In this manner, the engagement member is movable in an axial direction in relation to the second tube member by rotating the second engagement member in the thread. Additionally, the threaded connection can be designed so that engagement is only possible in one direction. This can ensure that the second tube member and the engagement member can not be disengaged once it has been engaged. Preferably, the threaded connection between said engagement member and said second tube member is adapted to only allow screwing in one direction.

In an embodiment, piercing of the second container prevents separation of the second container from the device by a combined action of the piercing means and the engagement member.

In an embodiment, the engagement member may prevent movement of the second container in an axial direction in relation to the second tube member, while the piercing means may prevent movement of the second container in a radial direction in relation to the second tube member.

The piercing prevents separation of the second container from the device by a combined action of the piercing means and the engagement member.

In an embodiment, a removable locking means engages the engagement member and the second tube member in order to prevent piercing of the second container before removal of the locking means.

In an embodiment, the device is adapted to retain the second container on the device, before piercing the second container, and so that the second container cannot be separated from the connector device.

In an embodiment, the device is adapted to retain the second container on the device in an intermediate position of the engagement member, said intermediate position being between an initial position, in which the second container is not pierced, and the activated position, in which the second container is pierced.

In an embodiment, the locking means is adapted to prevent the engagement member from moving from its intermediate position to its activated position.

In an embodiment, said engagement member, before removing the locking means, is restricted to approximately one rotation and preferably approximately a half rotation about a threaded connection to said second tube member, whereby it is moved from its initial position to its intermediate position.

In an embodiment, the device is adapted to retain the second container on the device by a combined action of a retaining member and the engagement member.

In an embodiment, the device is adapted to retain the second container on the device so that the engagement member prevents movement of the second container in an axial direction in relation to the second tube member, while the retaining member prevents movement of the second container in a radial direction in relation to the second tube member.

In an embodiment, the retaining member is constituted by a piercable cap covering a piercing end of the second piercing means before piercing of the second container.

According to the invention, said second tube member may comprise a means for activating and deactivating the fluid communication between said second tube member and said first tube member. Such means allows control of when fluid is allowed to flow between the two containers. The means for activating and deactivating the fluid communication between the first tube member and the second tube member may be an integral part of the first tube member or the second tube member. However, activation or deactivation of the fluid communication may also be achieved by external means, such as a tube or piercer being engaged with the second end of the first tube member.

In an embodiment, the means is a hinged sealing or membrane, which is an integral part of the device and has a hinge part, which is an integral part of the means, and a weakened part that can be broken by exerting a force on the side of the means facing the second tube member, whereby the proper force for opening of the means may be applied by the non-piercing end of the second piercing means as it is pushed towards the means as the engagement member is moved towards the first tube member along the second tube member.

In an embodiment, a wall part separating the first tube member from the second tube member is weakened in such a way that it may be broken in order to provide fluid communication between the first tube member and the second tube member.

In an embodiment, the non-piercing end of the second piercing means is adapted to break the wall part by axial displacement of the second piercing means.

In an embodiment, the wall part is strong enough to support the second piercing means in its axial direction during piercing of the second container without breaking.

In an embodiment, the retaining member has a shoulder adapted to abut an edge of a central opening in the engagement member, and wherein the second piercing means has a shoulder adapted to abut an edge of the retaining member, so that an axial displacement of the engagement member in relation to the second tube member may be transferred to the second piercing means via the retaining member.

In an embodiment, a second end of the engagement member has a collar for engaging and accommodating a neck of a vial, the collar having two flexible flanges, which can be pushed slightly radially outwards when the vial is pushed into the engaging end, so that when the vial is accommodated within the collar, the flanges of the collar snap back into their normal position, thus aiding in keeping the vial in place.

In an embodiment, the collar has a rim, which effectively prevents disengagement of a vial from the engagement member by an axial movement in relation to the engagement member.

In an embodiment, the first end of the first tube member is adapted to lock onto a neck of the first container so that the first container cannot be separated from the connector device again.

Preferably, said first end of the first tube member comprises resilient flanges with radially inwardly tapering tabs from a distal end to a proximal end. Such flanges with tabs may be used for engaging the first container and holding it in place.

More preferably, said first end of the first tube member further comprises a locking ring, which in an activated position prevents radially outwards movement of said flanges. Such a locking ring can be activated once a first container is engaged at the first end of the first tube member. The locking ring can help keep the first container in place by holding the flanges in place tightly around a neck part of the first container. The locking ring may be left out of the device. In some embodiments, an arrangement of flanges with tabs may be sufficient to engage and hold the first container.

In an embodiment, the locking ring is provided with an internal shoulder adapted to engage with a recess of each flange in the activated position of the locking ring so that the locking ring cannot leave its activated position and so that the flanges cannot move radially outwards.

Preferably, said first tube member comprises a first piercing means, such as a syringe or needle, for piercing said first container. Such a piercing means is suitable for penetrating into the first container, e.g. through a seal or cap. Specifically, a hollow piercing means may also act as a conduit of fluid between the first container and the first tube member.

In an expedient manner, said second end of said first tube member comprises a piercable seal. Such a seal can be pierced by e.g. a syringe at the end of an IV tube for allowing discharge of fluid from the device to the IV tube.

In an embodiment, the first end of the second tube member is in fluid communication with the second end of the first tube member for discharge of fluid from the device into the second container.

In an embodiment, the first tube member and the second tube member are arranged end to end, and preferably coaxially.

In an embodiment, the first end of the second tube member is in fluid communication with the first tube member at a position between the first tube member's first end and second end.

In an embodiment, the first tube member and the second tube member are manufactured as one piece.

In an embodiment, an inner tube member is arranged coaxially inside the first tube member, so that a needle of an IV tube may be inserted sealingly into the inner tube member in order to prevent fluid communication between the first end of the first tube member and the second tube member.

In an embodiment, the device further comprises a third tube member in fluid communication with said first tube member at a first end, and having at a second end an engagement member for engagement of a third container.

The invention further relates to a set comprising a connector device and a vial, wherein the engagement member is connected to the vial.

In an embodiment, the set further comprises a diluent container, wherein the first end of the first tube member is connected to the diluent container. The present invention also provides a method for sterile mixing of the contents of a first container and the contents of a second container by use of a device according to the invention, said method comprising the steps of:
engaging said first container at a first end of a first tube member of the device,
attaching said second container to an engagement member at a second end of a second tube member of the device,
piercing said second container,
establishing fluid communication between said first tube member and said second tube member, thus establishing fluid communication between said first container and said second container, and
mixing the contents of said first container and said second container,

wherein the step of piercing said second container also prevents separation of said device and said second container, so that the piercing of the second container cannot be undone, and so that the second container cannot be separated from the connector device after it has been pierced.

Such a method illustrates a suitable way of employing the device in order to mix the contents of two containers in a sterile manner.

Preferably, said piercing of said second container is achieved by a rotary movement of the engagement member. The matter is that the engagement member, which holds the second container, can be rotated in e.g. a thread of the second tube member. By such rotation, the second container can be brought closer to the second tube member, and can thus be pierced by the second piercing means comprised in the second tube member. Additionally, the thread can be adapted to only allow screwing in one direction, which entails that the second tube member and the engagement member can not be disengaged once they have been engaged.

More preferably, fluid communication is established by activation of a means for deactivating and activating fluid communication. Such a means can allow control of when fluid communication should be allowed. The means can for instance be controlled by rotary movement of the engagement member. The means for deactivating and activating fluid communication may for instance be a valve or a hinged sealing, which may be opened and optionally be closable after opening.

Optionally, the device according to the invention may be disposed of after use. Such disposal of the device after a single use makes it both easier and more safe to use the device since no cleaning is required and the risk of contamination, e.g. from previously used and unclean devices, is minimized.

The present invention also provides a use of a device according to the invention for sterile mixing of the contents of a first container and the contents of a second container.

### DESCRIPTION OF THE DRAWINGS

The invention and its many advantages will be described in more detail below with reference to the accompanying schematic drawings, which for the purpose of illustration show some non-limiting embodiments and in which

FIG. 1 shows a detailed perspective view of a device according to the invention, where the separate parts of the device are spaced apart in order to show each part more clearly,

FIG. 2 shows a detailed side view of a device according to the invention, where the separate parts of the device are assembled in order to illustrate the device in its assembled state,

FIG. 3 shows a detailed perspective view of a device according to the invention in its assembled state with a first container and a second container,

FIG. 4 shows a cross-sectional view of a device according to the invention, where the preferred means for activating and deactivating fluid communication between the first tube member and the second tube member is shown more clearly,

FIG. 5 shows an example of a threaded connection between the second tube member and the engagement being adapted to only allow screwing in one direction,

FIG. 6 shows a cross-sectional view of a device according to the invention, before connection with a first container and a second container,

FIGS. 7 to 11 show a cross-sectional view of the device in FIG. 6 at different stages of the connection procedure,

FIGS. 12 to 14 show a cross-sectional view of a different embodiment of the device in FIG. 6 at different stages of the handling procedure,

FIG. 15 shows a perspective view of a small bottle commonly known as a vial,

FIG. 16 shows a cross-sectional view of a detail of the vial in FIG. 16,

FIG. 17 shows an enlarged detail of FIG. 10,

FIG. 18 shows a radial cross-section through the second tube member 4 with the engagement member 14 mounted thereon,

FIG. 19 shows a detail of FIG. 18, and

FIG. 20 shows a cross-sectional view of the body part of a different embodiment of the device in FIG. 6.

All the figures are highly schematic, not necessarily to scale, and show only parts, which are necessary in order to illustrate the invention, other parts being omitted or merely suggested.

### DETAILED DESCRIPTION OF THE INVENTION

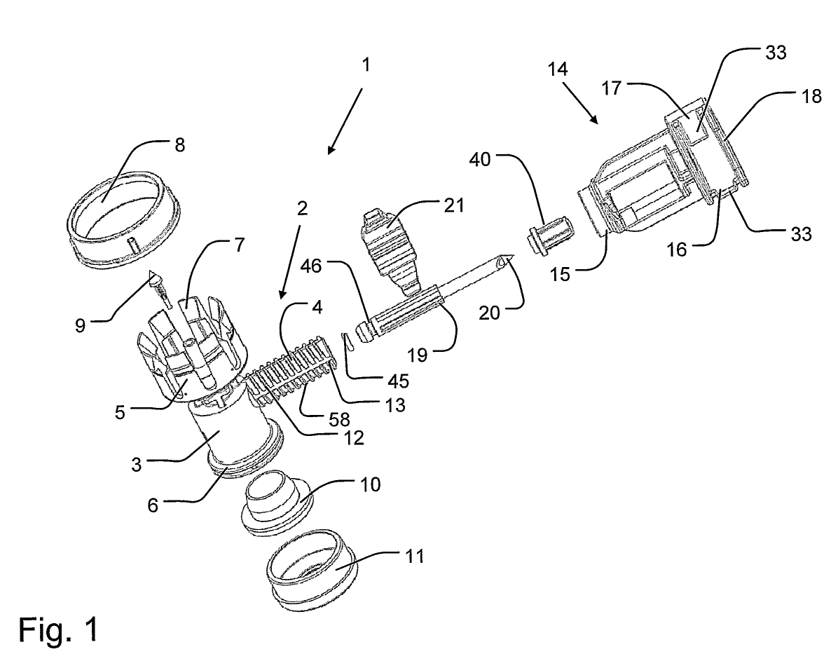

FIG. 1 shows a detailed view of a preferred embodiment of a device 1 according to the invention. The device 1 is shown in an exploded state with its separate parts spaced apart for the sake of more clearly showing each part. The body part 2 of this embodiment of the device 1 consists of a first tube member 3 and a second tube member 4. In the illustrated device 1, the second tube member 4 has a smaller diameter than the first tube member 3, but the device 1 may have other proportions.

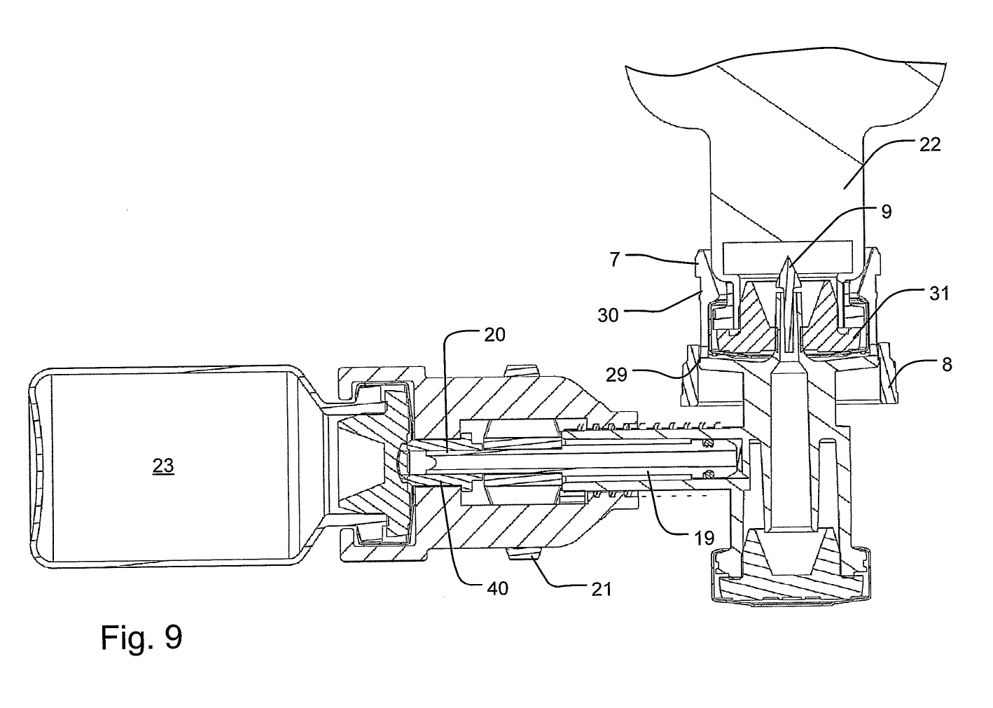

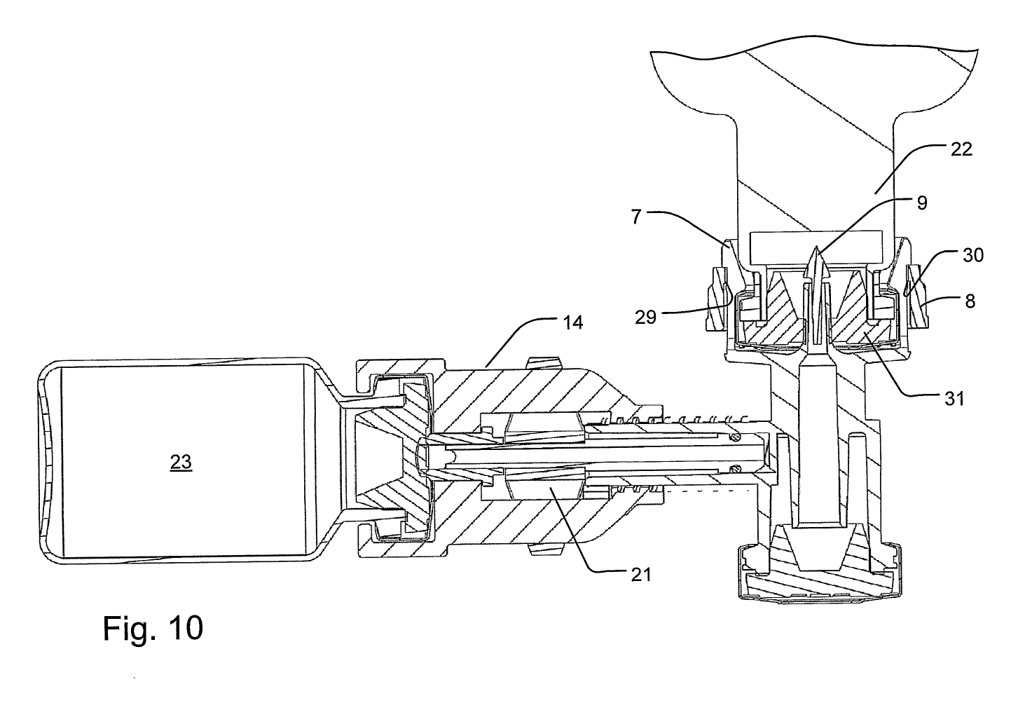

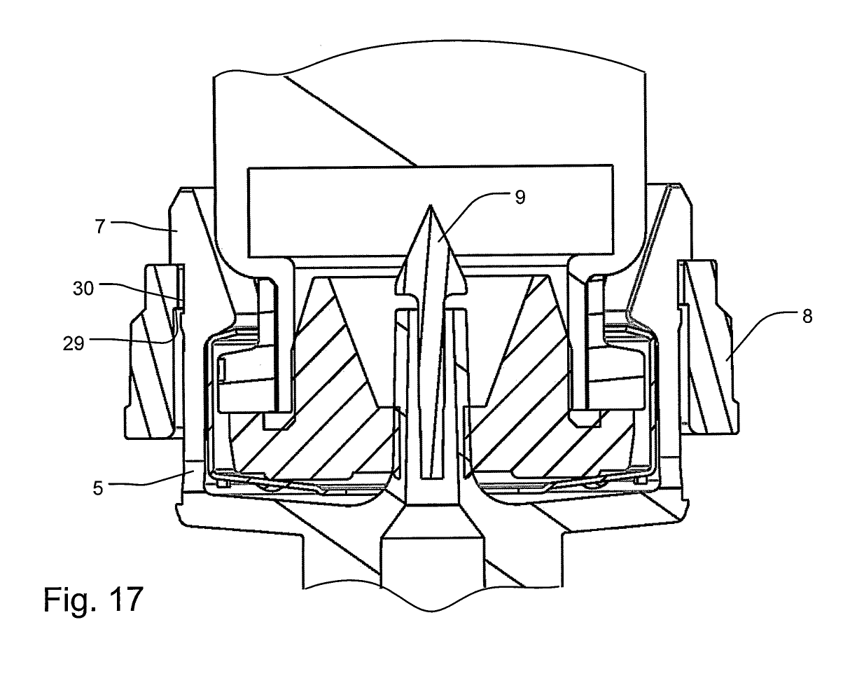

The first tube member 3 has a first end 5 and a second end 6. At the first end 5, the first tube member 3 has means for engaging a first container 22, such as the neck of a flexible plastic diluent bag-type container. As illustrated in FIG. 1, the first end 5 may have a number of flanges 7 with tabs tapering radially inwardly from a distal end to a proximal end in relation to the rest of the second tube member 3. The flanges 7 with the tabs are adapted for engaging the neck of the first container. When the neck of the container is pushed into engagement with the first end 5 of the first tube member 3, the flanges 7 bend slightly radially outwardly, allowing the neck of the first container to pass the tabs and fully engage with the first end 5. When the broad part of the neck has passed the tabs, the flanges 7 return to their normal position, whereby the tabs make it difficult to disengage the first container; see FIG. 9. The first container can be further secured in the engagement with the device 1 by employing a locking ring 8, which may slide over the outside of the flanges 7 once the first container is engaged, thus preventing the flanges 7 from bending radially outwards, and thus preventing disengagement of the first container. In FIGS. 10 and 17, the locking ring 8 has been displaced to an activated position, in which it prevents the flanges 7 from bending radially outwards. Furthermore, the locking ring 8 may be provided with an internal shoulder 29 adapted to engage with a recess 30 of each flange 7 in the activated position of the locking ring 8; see FIG. 17. Thereby, the locking ring 8 is locked in its activated position, so that the flanges cannot be bent radially outwards, and consequently so that the neck of the container cannot be disconnected from the connector device 1. In practice, it is impossible to move the locking ring 8 away from its activated position, as this would require that all the flanges 7 be pressed radially inwards simultaneously.

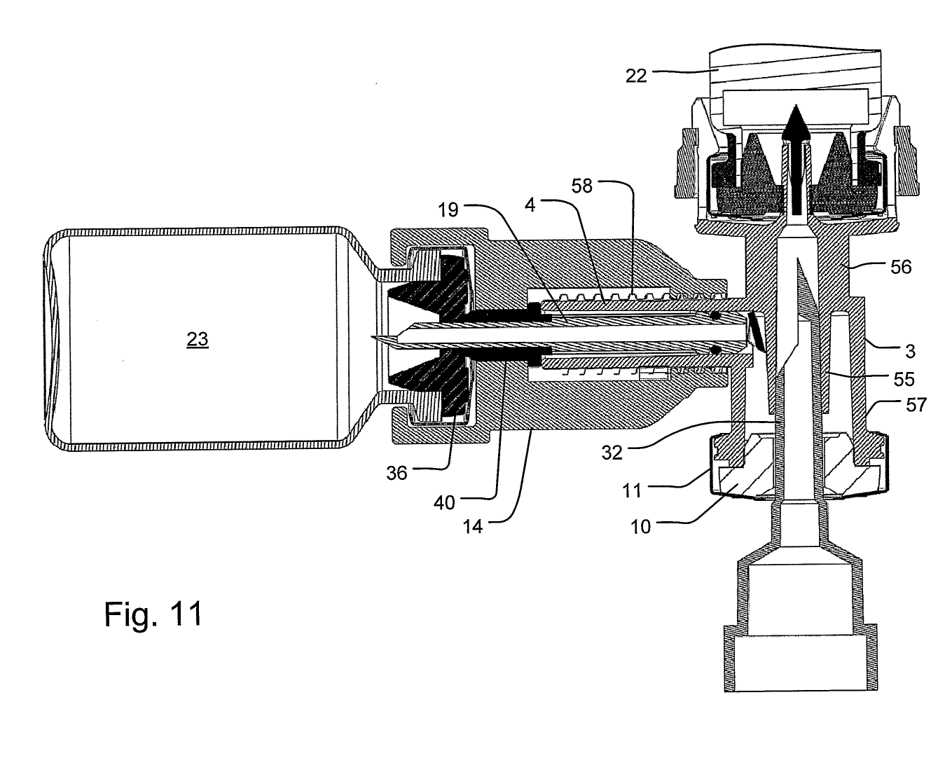

The first end 5 of the first tube member 3 may further comprise a first piercing means 9 as illustrated in FIG. 1. This first piercing means 9 may for instance be in the form of a needle or syringe suited for piercing the rubber membrane 31 of a typical diluent container. Other means for engaging a first container may also be employed at the first end 5 of the first tube member 3. In a specific embodiment of the invention, a first container, typically containing a diluent, such as a potassium chloride solution, is attached to the first end 5 of the first tube member 3 of the device 1. Thus, the device 1 may be supplied to the customer with a diluent container or other container already attached. Optionally, the device 1 may also be delivered with a second 23 container attached, either alone or in addition to an attached first container. The second end 6 of the first tube member 3 is adapted for discharge of fluid from the device 1. For instance, the second end 6 may comprise a rubber sealing 10 and an aluminium cap 11, of the type also typically used for medical vials. Such a rubber sealing 10 may for instance be pierced by a needle 32 attached to an IV tube, thus allowing discharge of fluid from the device 1 into the tube and further into a patient; see FIG. 11. As it is also seen in these figures, the needle 32 of the IV tube is inserted sealingly into an inner tube member 55 arranged coaxially inside the first tube member 3, so that fluid communication between the first container 22 and the second container 23 is impossible, thereby preventing flow-back of fluid into the second container 23 after mixing, as will be further discussed below. The first tube member 3 is composed by a first section 56 having a smaller diameter and a second section 57 having a larger diameter. The first section 56 constitutes the first end 5 of the first tube member 3 and extends as the inner tube member 55 inside the second section 57, whereby the second tube member 4 is connected to the second section 57.

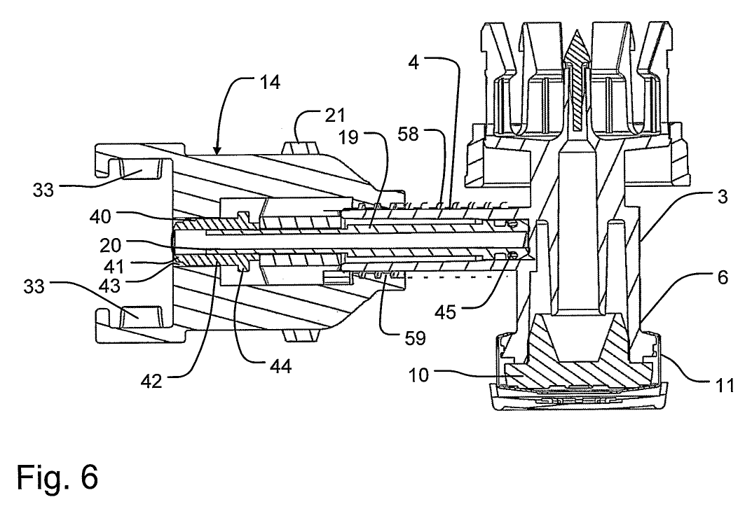

The second tube member 4 has a first end 12 connected to, and in fluid communication with, the first tube member 3 and a second end 13 distal from the first tube member 3. The illustrated second tube member 4 has an external screw thread 58 in its entire length. The thread engages a corresponding thread 59 of the engagement member 14 and is best seen in FIGS. 1 to 4; whereas in FIGS. 6 to 11 the thread is partly schematic illustrated by means of dots. The shown thread is right handed, but may as well be left handed if desired. The thread may also extend only along part of the length of the second tube member 4. In other embodiments of the device 1, the thread may be entirely left out or replaced by other features, such as sliding means. In particular, the thread may be replaced by a not shown ratchet mechanism or the like permitting the engagement member 14 to be displaced axially along the second tube member 4 in the direction of the first tube member 3 in such a way that the engagement member 14 cannot be returned to its initial position. The pitch of the thread may be chosen as desired for the specific purpose. A low pitch may be desirable in order to avoid quick and unintended on- or off-screwing of the engagement member 14, which has a corresponding internal thread at its first end 15.

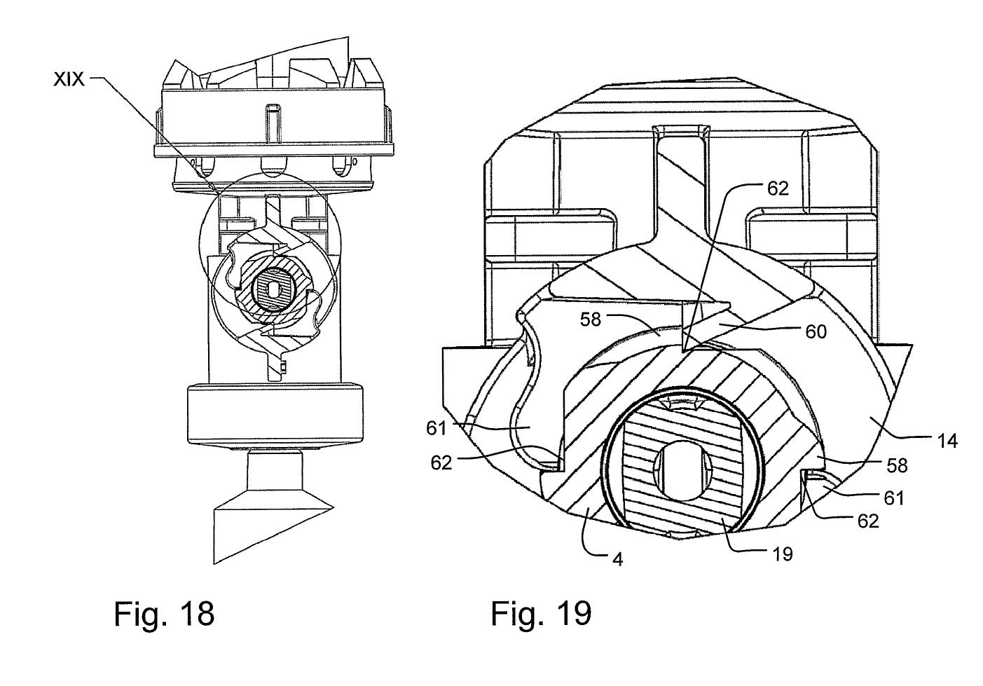

FIGS. 18 and 19 show a radial cross-section through a part of the thread connection between the second tube member 4 and the engagement member 14. FIG. 19 shows that the engagement member 14 is provided with resilient tabs 60, 61 engaging with notches 62 in the thread 58 of the second tube member 4 in such a way that the engagement member 14 can only be turned clockwise in the figure, thereby allowing the engagement member 14 only to be screwed onto the second tube member 4, but not to be screwed off again.

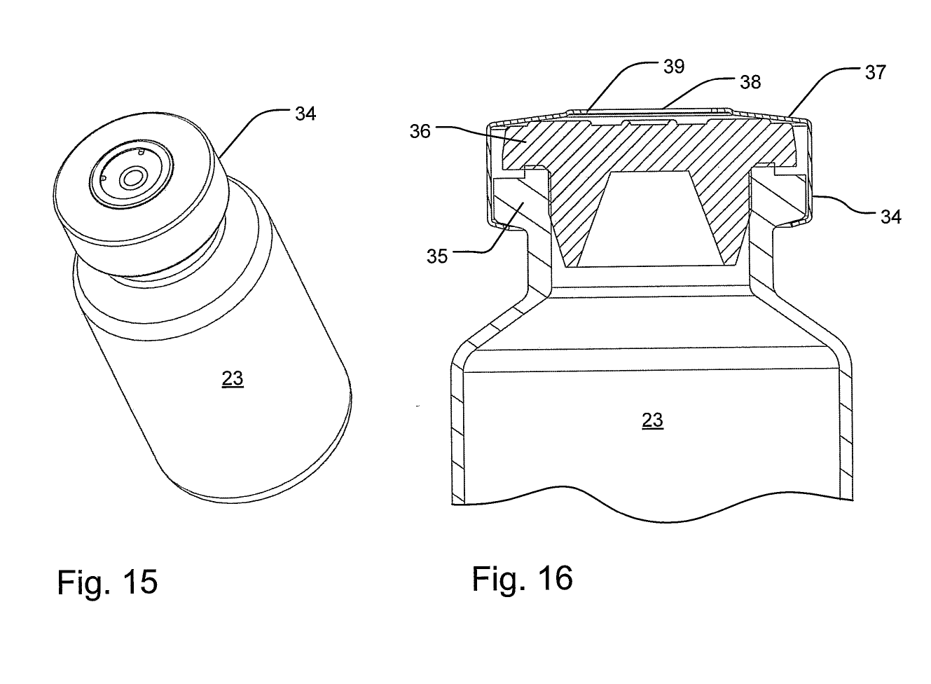

The second end 16 of the engagement member has a collar 17 for engaging and accommodating a neck of a vial. An example of a vial 23 having a neck 34 is shown in FIG. 15. FIG. 16 shows a cross-sectional view of the neck 34 of the vial 23. The neck 34 is a so-called capsulate neck formed by a flange 35, in which a rubber seal 36 is inserted, and a metal cap 37 encloses the flange 35 and the rubber seal 36. The metal cap 37 has a central opening 38 having a rim 39, so that the rubber seal 36 may be pierced through the opening 38 as explained below. The vial may be a standardized product known to the person skilled in the art.

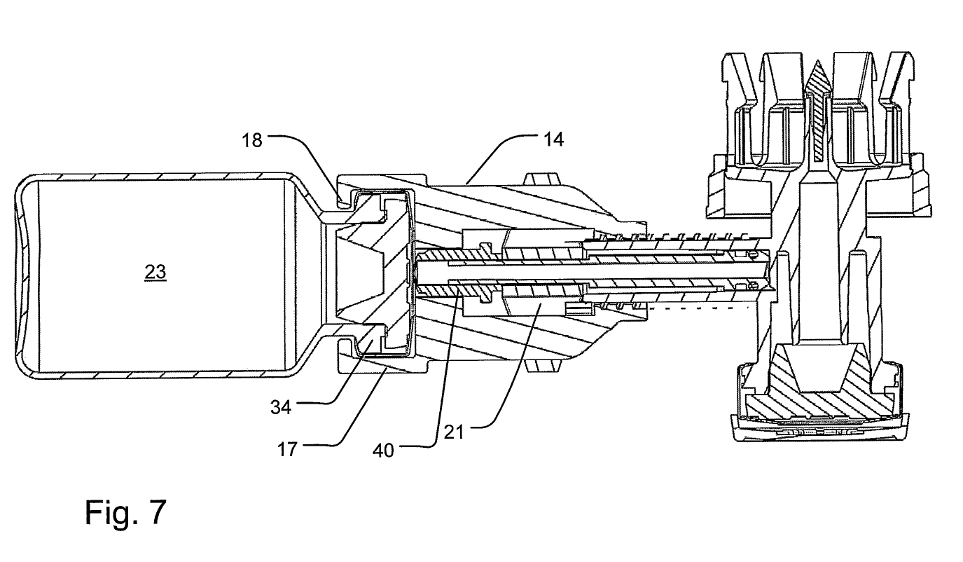

The collar 17 has two flexible flanges 33, which can be pushed slightly radially outwards when the vial is pushed into the engaging end 16. When the vial is accommodated within the collar 17, the flanges 33 of the collar 17 snap back into their normal position, thus aiding in keeping the vial in place. Apart from the flanges 33, the collar is rigid and has a rim 18, which effectively prevents disengagement of a vial from the engagement member 14 by an axial movement in relation to the engagement member 14. Thus, the vial can only be disengaged by moving it out of the collar 17 the same way it was moved into the collar 17, namely by use of the gap in the collar 17 between the flanges 33, i.e. by a radial movement in relation to the engagement member 14. FIG. 6 shows the connector device 1 before insertion of the vial 23 in the engagement member 14, and FIG. 7 shows the connector device 1 with the vial 23 inserted into the engagement member 14.

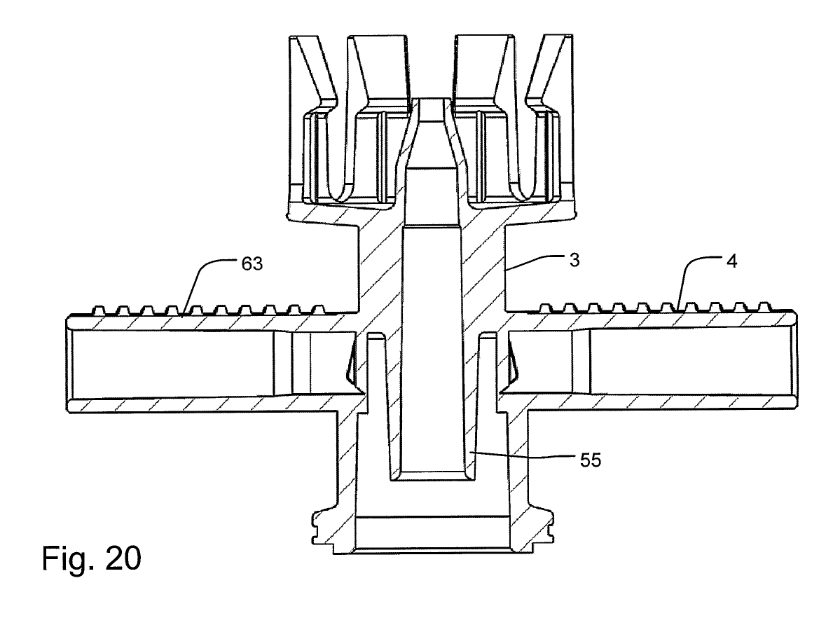

Orthogonality between the first tube member 3 and the second tube member 4 may enable horizontal mounting of the second container 23. A horizontal mounting of the second container makes for an easier and faster use of the connection device. However, the first tube member 3 and the second tube member 4 may form any suitable angle with one another, such as for instance 30, 45 or 75 degrees. Furthermore, in an embodiment, the first tube member 3 and the second tube member 4 are arranged coaxially and end to end. In this embodiment, the tube members 3, 4 may even be formed as one single tube member. A further tube member for discharge of fluid to, for instance, an intravenous catheter, may be arranged at an angle to the tube members 3, 4. On the other hand, the connector device 1 according to the invention may be adapted to be connected to a diluent container having two openings with a neck for connection; one opening for the connector device and another opening for an intravenous catheter. In that case, the connector device need not be provided with said further tube member for discharge of fluid. The device may even be provided with a third tube member 63 having an engagement member for a third container; see FIG. 20 illustrating an example of the body part 2 of such an embodiment. The device may in fact be provided with any suitable number of tube members with corresponding engagement members.

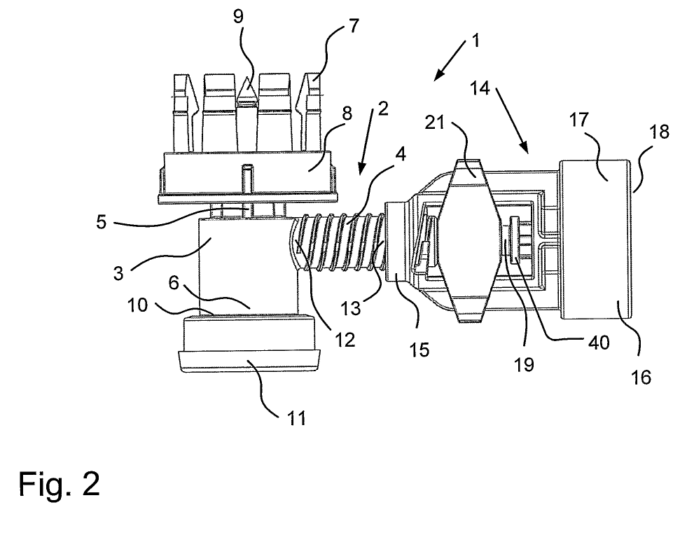

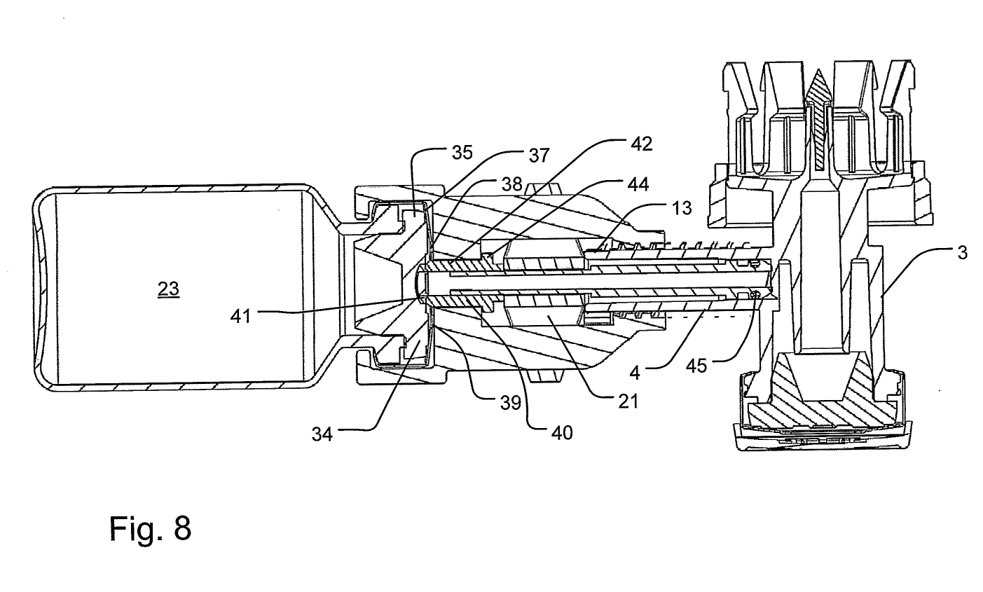

FIG. 2 is a cross-sectional view of a preferred embodiment and illustrates a second piercing member 19. This second piercing member 19 is adapted for piercing the second container, while the second container is engaged in the engagement member 14. The second piercing means 19 is typically housed partly within the second tube member 4, without extending into the first tube member 3 and with the piercing end 20 extending beyond the second tube member but not beyond the engagement member 14. This prevents any contact between the piercing means 19 and the surroundings, which increases the safety for the user as well as the patient. Furthermore, the safety is increased by means of a piercable cap 40 forming a retaining member and covering the piercing end 20 of the piercing means 19 before piercing; see for instance FIG. 6. The piercable cap 40 has a top part 41 with a smaller diameter and an intermediate part 42 with a larger diameter fitting into an axial bore 43 in the engagement member 14. Furthermore, the piercable cap 40 has a flange 44 being opposed to the top part 41 and having larger diameter than the intermediate part 42, so that it is prevented that the piercable cap may pass through the axial bore 43 in the engagement member 14. The top part 41 of the piercable cap 40 fits into the central opening 38 of the metal cap 37 on the vial 23, so that, in an intermediate position of the engagement member 14, the piercable cap 40 may prevent disengagement of the vial 23 from the engagement member 14 by radial displacement, because the top part 41 will abut the rim 39 of the central opening 38. In this intermediate position, neither the piercable cap 40 nor the rubber seal 36 of the vial 23 are pierced; see FIG. 8. A locking means 21 may be employed to prevent movement of the engagement member 14 along the second tube member 4 until the locking means has been removed. The engagement member 14 may be prevented from displacement from its intermediate position by means of the locking means 21, as the locking means 21 maintains a certain distance between the piercable cap 40 and the second end 13 of the second tube member 4.

The piercing means 19 may be of any kind suitable for piercing the second container, for instance a needle or syringe. Typically, the second piercing member 19 is hollow in order for it to serve as a conduit of fluid from a pierced second container to the second tube member 4. Sealing rings, such as O-rings may also be comprised in the second tube member 4. Preferably, an O-ring 45 is located in a recess 46 in the non-piercing end of the piercing means 19, thereby sealing against the inner wall of the second tube member 4.

As will be appreciated by the skilled person from the above description of a preferred embodiment of the invention, the process of piercing the second container is accomplished by first placing it in the second end 16 of the engagement member 14 by pushing the neck of the second container past the flanges of the collar 17. Secondly, the engagement member 14 is moved, for instance by rotating it along a thread, along the second tube member 4 in the direction of the first tube member 3. Eventually, the piercing end 20 of the piercing means 19 extending from the second tube member 4 will pierce the piercable cap 40 and the lid or rubber seal 36 of the second container 23. Once this piercing has taken place, the piercing means 19 effectively prevents movement of the second container in a radial direction in relation to the engagement member 14. Thus, while the second container is pierced, it is prevented from axial movement by the rim 18 of the engagement member 14, and prevented from radial movement by the piercing means 19. Thus, it is securely locked into position and separation of the second container and the device 1 is effectively prevented, without any additional actions from the user.

FIG. 2 shows an embodiment of a device 1 according to the invention. The device 1 is shown in its assembled state.

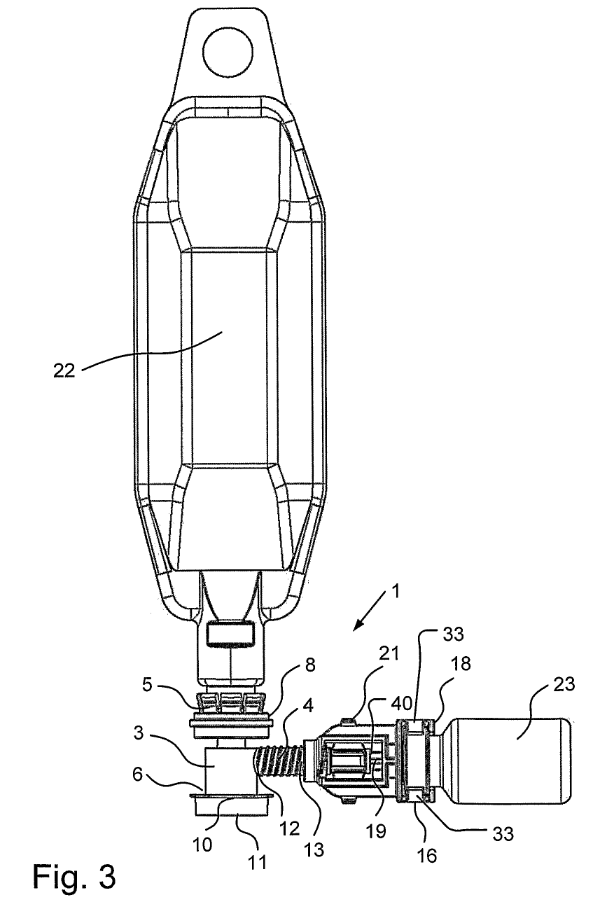

FIG. 3 shows an embodiment of a device 1 according to the invention, wherein two containers are attached to the device. The first container 22 is illustrated as a standard diluent container while the second container 23 is illustrated as a vial. The container may be of any other desirable type and the device 1 may be adapted to fit any such containers. In a preferred embodiment the device is adapted to fit all containers with necks according to the ISO standards.

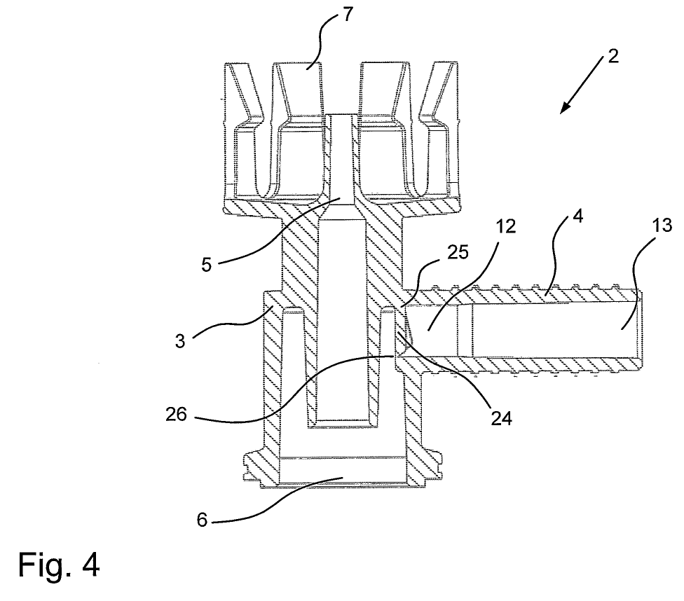

FIG. 4 shows a cross-section of an embodiment of a device 1 according to the invention. In this particular preferred embodiment, the device 1 comprises a means 24 for deactivating and activating the fluid communication between the second tube member 4 and the first tube member 3. In this particular embodiment of the device 1, the means 24 is illustrated as a hinged sealing or membrane, which is an integral part of the device 1. The sealing has a hinge part 25, which is an integral part of the means 24, and a weakened part 26. The weakened part 26 can be broken by exerting a force on the side of the means 24 facing the second tube member 4. This side of the means 24 typically (and as seen in the FIG. 4) has a broadened part, which ensures correct transfer of force to the means 24. When the weakened part 26 is broken, the means 24 flips open by a rotation around the hinge part 25, thus establishing fluid communication between the second tube member 4 and the first tube member 3. The proper force for opening of the means 24 may be applied by the non-piercing end of the second piercing means 19. For instance, the non-piercing end of the second piercing means 19 may be pushed towards the means 24 as the engagement member 14 is moved towards the first tube member 3 along the second tube member 4, see FIG. 11. The means 24 may optionally be closable after having been opened.

Also, a valve can be arranged in the second tube member 4 in order to be able to control when liquid communication is possible between the first tube member 3 and the second tube member 4. The opening and closing of such a valve may for instance be controlled by the axial movement of the engagement member 14 in relation to the second tube member 4. For instance, when the engagement member 14 is positioned as far a possible towards the first tube member 3 on the second tube member 4, the valve may be automatically shut. When the engagement member 14 is then moved a bit away from the first tube member 3 along the second tube member 4, the valve may be opened. In this way, the second container can be pierced by moving the engagement member 14 all the way onto the second tube member 4, which will render the valve closed. Afterwards, when the contents of the second container should be mixed with the contents of the first container, the valve may be reopened by moving the engagement member 14 slightly outwards along the second tube member 14. After the mixing has taken place, the valve can then be shut again by moving the engagement member 14 back towards the first tube member 3.

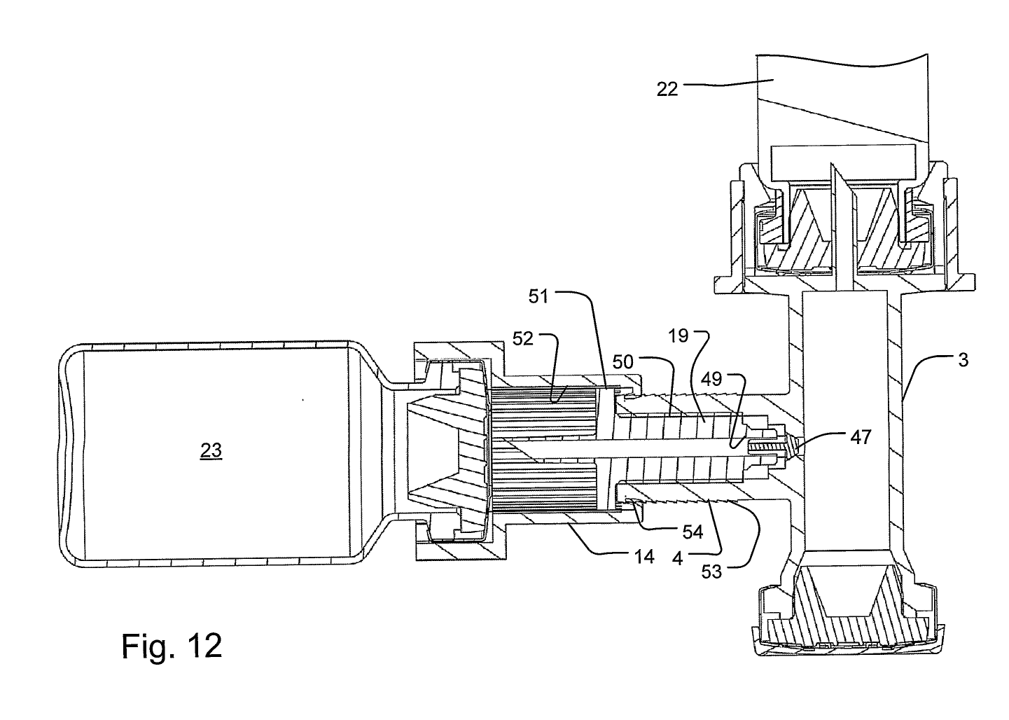

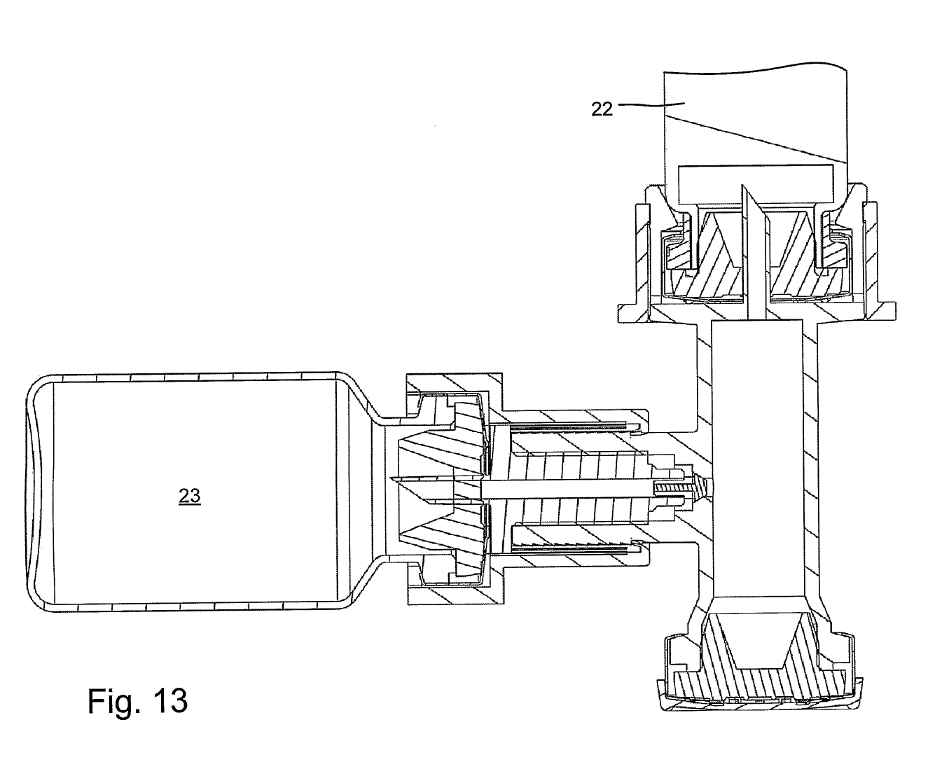

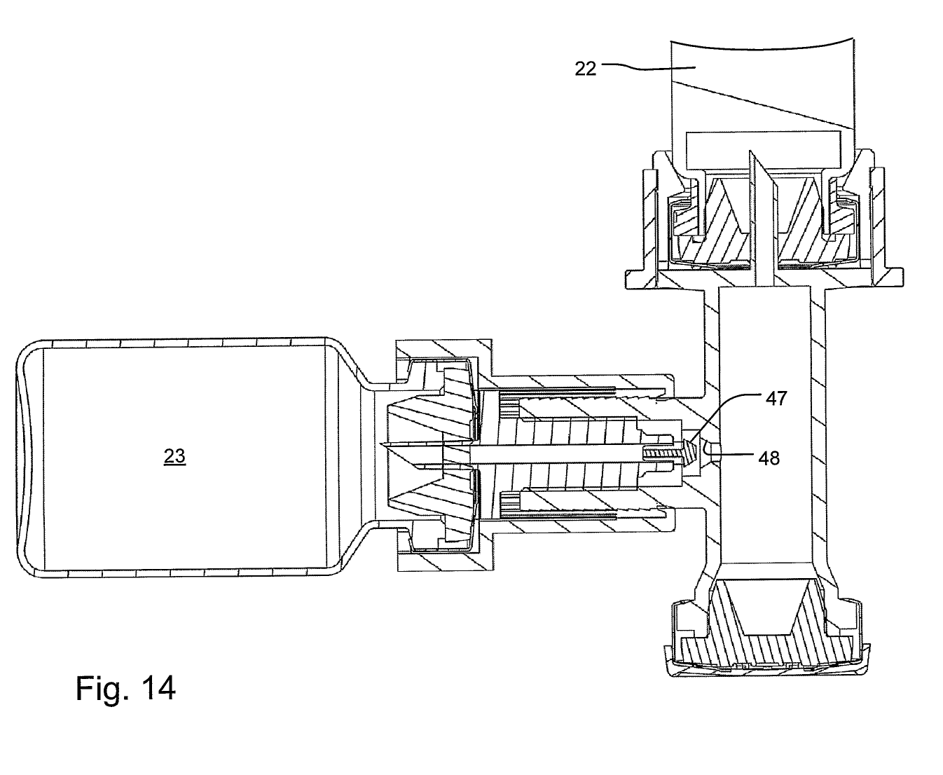

FIGS. 12 to 14 show different stages of the operation procedure of another embodiment of the connector device 1. In this embodiment, the means for deactivating and activating the fluid communication between the second tube member 4 and the first tube member 3 is a valve body 47 axially displaceable in the second tube member 4 against a valve seat 48. The valve body 47 is located in a bore 49 in the non-piercing end of the piercing means 19. The piercing means 19 is axially displaceable in the second tube member 4 by means of a thread connection 50. The piercing means 19 may be rotated by the engagement member 14 by means of flanges 51 of the piercing means 19 arranged axially displaceably in nuts 52 of the engagement member 14; see FIG. 12. In FIG. 12, the valve body 47 closes the fluid connection between the second tube member 4 and the first tube member 3, and the engagement member 14 is in its initial position, displaced away from the first tube member 3, and the rubber seal 36 is not pierced yet. In FIG. 13, the engagement member 14 has been displaced axially along the second tube member 4 in the direction of the first tube member 3, whereby a ratchet mechanism 53, 54 prevents that the engagement member 14 returns to its initial position. The rubber seal 36 has been pierced, but the valve body 47 is still in its closed position. In FIG. 14, the piercing means 19 has been rotated by the engagement member 14, whereby it has been displaced axially inside the second tube member 4, whereby the valve body 47 has been moved to its open position. In this way, the valve body 47 may be opened and closed as required by rotation of the engagement member 14. This embodiment may especially be advantageous where more than one tube member having an engagement member for attachment of a vial are provided for mixing its content with the diluent in a diluent container, as in the embodiment explained above. In that case, fluid connection may be provided separately between each vial and the diluent container, as it may be required, simply by opening and closing the corresponding valves.

Furthermore, connection of the device 1 to the end of e.g. an IV tube at the second end 6 of the first tube member 3, may provide for a deactivation or disruption of the fluid communication between the second tube member 4 and the first tube member 3. For instance, the end of an IV tube may be connected to the first tube member 3 in such a way as to make flow of fluid from the second tube member 4 into the IV tube impossible, as explained above. This may be desirable in order to avoid flow of undiluted liquid or solid from the second container 23 into the IV tube. By such an arrangement, an additional level of safety is achieved. This may be necessary since it can be difficult to completely mix the contents of the second container 23 with the contents of the first container 22. Thus, some undiluted material will often remain inside the second container 23 or even in the second tube member 4. Such undiluted material may potentially be very harmful to the patient if the material is allowed to enter the IV tube.

FIG. 3 and FIG. 4 illustrate that once the first container 22 and the second container 23 have been connected to the device 1 in a preferred embodiment and upon being pierced, a system for fluid communication that is hermetically sealed from the surroundings has been achieved. This prevents any fluid communication from the system to the surroundings, which thus minimizes the risk of spreading e.g. medicine to the surroundings. Likewise, the risk of contamination of the system from the surroundings is minimized.

Advantageously, the first container 22 and the second container 23 are connected to the device 1 at the time of production, in order to make it faster, safer and easier to use for the user. Furthermore, this may enable larger flexibility in the production as well as easier storage at e.g. clinics and hospitals. Additionally, if the device 1 is delivered with the first container 22 and the second container 23 pre-connected but still un-pierced, the device 1 can be classified as a product with a generic expiry date which can be mass-produced.

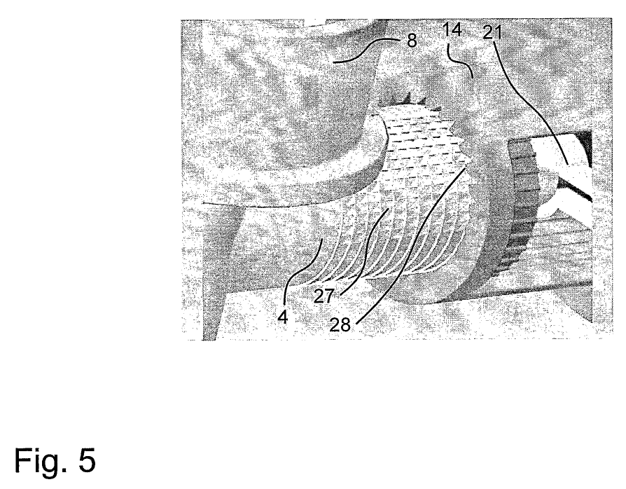

FIG. 5 shows a detail of an embodiment of the device 1. In this detailed view, parts of the second tube member 4, the locking ring 8 at the second tube member 3, the engagement member 14 and the locking means 21 can be seen. Furthermore, in this embodiment the threaded connection is designed so that engagement is only possible in one direction, i.e. that the engagement member 14 can only be rotated in one direction in the thread of the second tube member 4. This can for instance be accomplished as illustrated in FIG. 5 by incorporating small barbs 27 at the second tube member 4 and by incorporating taps 28 for engaging said barbs 27 at the engagement member 14. In this manner the engagement member 14 is gradually “clicked” on to the second tube member 4 as it is rotated in the thread, thus preventing rotation of the engagement member 14 in the opposite direction. Thereby it is achieved that the piercing of the second container 23, which is achieved by movement of the engagement member 14 towards the first tube member 3 along the second tube member 4, cannot be undone. Thus, the second container 23 cannot be separated from the device 1, and there is consequently no risk of leakage or spillage from the second container 23. This unidirectional movement of the engagement member 14 along the second tube member 4 can be achieved in a number of other ways, which would be clear to the skilled person from the present disclosure. That the second container 23 can not separated from the connection device 1 after it has been pierced ensures a 100% traceability of the medication given to the patient, and thus rules out the possibility of double-medication.

FIGS. 6 to 11 illustrate the steps of operation of an embodiment according to the invention. FIG. 6 shows the connector device 1 ready for use. In FIG. 7 the neck of a vial 23 has been attached to the engagement member 14 by radial insertion into the collar 17. In FIG. 8, the engagement member 14 has been rotated approximately half a rotation about the second tube member 4, whereby it has been displaced axially along the second tube member 4 in the direction of the first tube member 3. Thereby, the piercable cap 40 forming a retaining member has been displaced so that its top part 41 extends into the opening 38 in the metal cap 37 on the vial 23, thereby preventing detachment of the vial from the connector device 1, as explained above. In FIG. 9, the diluent container 22 has been engaged by the flanges 7 of the first end 5 of the first tube member 3, and in FIG. 10 the locking ring 8 has been displaced to an upper position preventing disconnection of the diluent container 22, as explained above. In this situation, mixing is prepared for, but not yet executed. In fact, the containers 22, 23 cannot be disconnected from the connector device 1, so the set comprising the connector device and the containers may be stored ready for use, tamper proof, as a prescribed mixture to be given to a patient. In FIG. 11, the locking means 21 has been removed, thereby enabling further rotation of the engagement member 14 to the situation shown in the figure, whereby the retaining member 40 and the rubber seal 36 of the vial 23 have been pierced, and the means 24 for deactivating and activating the fluid communication between the second tube member 4 and the first tube member 3 has been broken to open fluid communication by means of displacement of the non-piercing end of the piercing means 19. Furthermore, a needle 32 attached to an IV tube has been inserted through the rubber sealing 10 and into sealing contact with the inner tube member 55 of the first tube member 3, thus allowing discharge of fluid from the diluent container 22 into the IV tube and further into a patient. However, just before insertion of the needle 32 of the IV tube, the contents of the vial 23 has been mixed with the diluent of the diluent container 22 by tilting the device from side to side.

The device 1 according to the invention may be made of any suitable material. Preferably it may be made of a polymer material, such as polyester, polyethylene, polypropylene. More preferably the device 1 may be made of a relatively hard, durable and heat-resistant polymer material such as polycarbonate. The device 1 may optionally be made of a number of different materials. It may be preferable to make the device 1 of materials, which can endure sterilization processes such as auto-clavation. Advantageously, the device 1 may be made of the same material used for the first container 22 and the second container 23, so that no additional test of stability is needed. In a preferred embodiment, the different parts of the device 1 may be coloured in order to ensure ease of use and minimize the risk of wrong use of the device.

Although the invention has been described in connection with certain preferred embodiments, it will be evident for a person skilled in the art that several modifications are conceivable without departing from the invention as defined by the following claims. Especially, the embodiments shown may be combined in any suitable way. For instance, the first container 22 may be connected to the first tube member 3 of the connector device 1 by means of an engagement member similar to that of the second tube member 4. Similarly, the second container 23 may be connected to the second tube member 4 of the connector device 1 by means of flanges similar to those of the first tube member 3.

What is claimed is:

1. A connector device for establishing fluid communication between a first container and a second container, said device comprising a first tube member having a first end for engaging the first container and a second end for discharge of fluid from the device, said device further comprising a second tube member in fluid communication with said first tube member at a first end, and having at a second end an engagement member for engagement of said second container, wherein said second tube member comprises a second piercing means, such as a syringe or needle, characterized in that said engagement member in an activated position allows for piercing of the second container by the second piercing means and prevents separation of the second container and the device, so that the piercing of the second container cannot be undone, and so that the second container cannot be separated from the connector device after it has been pierced and wherein a wall part separating the first tube member from the second tube member is weakened in such a way that it may be broken in order to provide fluid communication between the first tube member and the second tube member and the non-piercing end of the second piercing means is adapted to break the wall part by axial displacement of the second piercing means.

2. A connector device according to claim 1, wherein said engagement member has a connection to said second tube member selected from the group consisting of a sliding connection, a gradually click-on connection, or a threaded connection.

3-5. (canceled)

6. A connector device according to claim 1, wherein piercing of the second container prevents separation of the second container from the device by a combined action of the piercing means and the engagement member.

7. A connector device according to claim 1, wherein the engagement member may prevent movement of the second container in an axial direction in relation to the second tube member, while the piercing means may prevent movement of the second container in a radial direction in relation to the second tube member.

8. A connector device according to claim 1, wherein a removable locking means engages the engagement member and the second tube member in order to prevent piercing of the second container before removal of the locking means.

9-10. (canceled)

11. A connector device according to claim 8, wherein the locking means is adapted to prevent the engagement member from moving from its intermediate position to its activated position.

12. A connector device according to claim 8, wherein said engagement member, before removing the locking means, is restricted to approximately one rotation and preferably approximately a half rotation about a threaded connection to said second tube member, whereby it is moved from its initial position to its intermediate position.

13. A connector device according to claim 8, wherein the device is adapted to retain the second container on the device by a combined action of a retaining member and the engagement member.

14. A connector device according to claim 8, wherein the device is adapted to retain the second container on the device so that the engagement member prevents movement of the second container in an axial direction in relation to the second tube member, while the retaining member prevents movement of the second container in a radial direction in relation to the second tube member.

15. A connector device according to claim 13, wherein the retaining member is constituted by a piercable cap covering a piercing end of the second piercing means before piercing of the second container.

16-33. (canceled)

34. A connector device according to claim 1, wherein an inner tube member is arranged coaxially inside the first tube member, so that a needle of an IV tube may be inserted sealingly into the inner tube member in order to prevent fluid communication between the first end of the first tube member and the second tube member.

35. A connector device according to claim 1, wherein the device further comprises a third tube member in fluid communication with said first tube member at a first end, and having at a second end an engagement member for engagement of a third container.

36-37. (canceled)

38. A method for sterile mixing of the contents of a first container and the contents of a second container by use of a device according to claim 1, said method comprising the steps of:
engaging said first container at a first end of a first tube member of the device;
attaching said second container to an engagement member at a second end of a second tube member of the device;
piercing said second containers;
establishing fluid communication between said first tube member and said second tube member, thus establishing fluid communication between said first container and said second container; and
mixing the contents of said first container and said second container;
wherein the step of piercing said second container also prevents separation of said device and said second container, so that the piercing of the second container cannot be undone, and so that the second container cannot be separated from the connector device after it has been pierced.

39. A method according to claim 38, wherein said piercing of said second container is achieved by a rotary movement of the engagement member.

40. A method according to claim 38, wherein fluid communication is established by activation of a means for deactivating and activating fluid communication.

41. (canceled)
